(19) United States
(12) Patent Application Publication
(10) Pub. No.: US 2007/0163730 A1
(43) Pub. Date: Jul. 19, 2007

(54) Ladder tape and bottom rail positioning structure for venetian blinds

(75) Inventor: Wen Ying Liang, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: Ching Feng Home Fashions Co., Ltd.

(21) Appl. No.: 11/331,131

(22) Filed: Jan. 13, 2006

(51) Int. Cl. E06B 9/382; E06B 9/384

(52) U.S. Cl. 160/178.3

(57) ABSTRACT

A ladder tape and bottom rail positioning structure for Venetian blinds comprises head and bottom rails, lift cords, wide-type ladder tapes, pulley seats, and slats wherein the ladder tape has both ends extending to wind around the underside of the bottom rail with an overlapping portion formed and secured thereto via multiple stapling elements. A flexible plastic positioning cover having insert ends protruding thereon is mounted to the underside of the bottom rail corresponding to the overlapping portion thereof, and the inert ends are precisely hooked adjacent to both lateral sides of the ladder tape to form a limiting groove there-between, permitting stable position of the ladder tape clamped between the positioning cover and the bottom rail and restrained by the limiting grooves thereof. Thus, the overlapping portion of the ladder tape and the stapling elements can be accurately concealed inside the positioning cover for decorative purpose thereof.

### BACKGROUND OF THE INVENTION

The present invention is related to a ladder tape and bottom rail positioning structure for Venetian blinds, comprising a Venetian blind made up of head and bottom rails, lift cords, wide-type ladder tapes, pulley seats, and a plurality of slats wherein a flexible plastic positioning cover having insert ends and a cavity disposed thereon is mounted to the underside of the bottom rail, precisely corresponding to an overlapping portion of the ladder tape fixed to the bottom rail thereof so as to conceal the overlapping portion and stapling elements therein for decorative purpose and provide a delicate finish to boost the quality of the Venetian blind as a whole thereby.

Please refer to FIG. 1. A conventional Venetian blind 10 is equipped with a plurality of slats 11 evenly spaced and located onto a wide-type ladder tape 12 having both ends directly extended to overlap at the underside of the bottom rail 13 and staple thereto for location to complete the assembly thereof. As a result, stapling elements 14 and an overlapping portion 15 of the ladder tape 12 are directly exposed outside, which gives an indelicate appearance to the Venetian blind 10 thereof. Besides, the ladder tape 12 is simply fixed to the bottom rail 13 via the stapling elements 14. When the Venetian blind 10 affected by outer force like the blowing of wind or the operation of the lift cords is subjected to swinging movement, the ladder tape 12 tends to slide or tilt along the surface of the bottom rail 13 and cause the slats 11 to shake along therewith, which makes the conventional Venetian blind 10 rather unstably positioned in application.

### SUMMARY OF THE PRESENT INVENTION

It is, therefore, the primary purpose of the present invention to provide a ladder tape and bottom rail positioning structure for Venetian blinds, comprising a Venetian blind made up of head and bottom rails, lift cords, wide-type ladder tapes, pulley seats, and a plurality of slats wherein a flexible plastic positioning cover having insert ends and a cavity disposed thereon is mounted to the underside of the bottom rail, precisely corresponding to an overlapping portion of the ladder tape fixed to bottom rail thereof so as to conceal the overlapping portion and stapling elements therein for decorative purpose and provide a delicate finish to boost the quality of the Venetian blind as a whole.

It is, therefore, the second purpose of the present invention to provide a ladder tape and bottom rail positioning structure for Venetian blinds wherein the insert ends of the positioning cover are hooked to frame edges of the bottom rail in a location precisely adjacent to both lateral sides of the ladder tape thereof, permitting the ladder tape to be stably clamped between the positioning cover and the bottom rail and restrained by the insert ends thereof so that the ladder tape can avoid the risk of sliding to and forth over the surface of the bottom rail when the Venetian blind is swung by external force to ensure a synchronic movement of the ladder tape with the bottom rail in an even and stable manner, achieving the best state of application thereof.

### BRIEF DESCRIPTION OF THE DRAWINGS

FIG. 1 is a diagram showing the bottom rail of a conventional Venetian blind combined with a wide-type ladder tape.

FIG. 2 is an exploded perspective view of the present invention.

FIG. 3 is a perspective view of a positioning cover of the present invention.

FIG. 4 is a diagram showing the positioning cover hooked to a bottom rail of the present invention with an overlapping portion of a ladder tape and stapling elements completely concealed in a cavity of the positioning cover thereof.

FIG. 5 is an assembled perspective view of the present invention.

FIG. 6 is a diagram showing the ladder tape clamped between the positioning cover and the bottom rail and restrained by a limiting groove of the present invention.

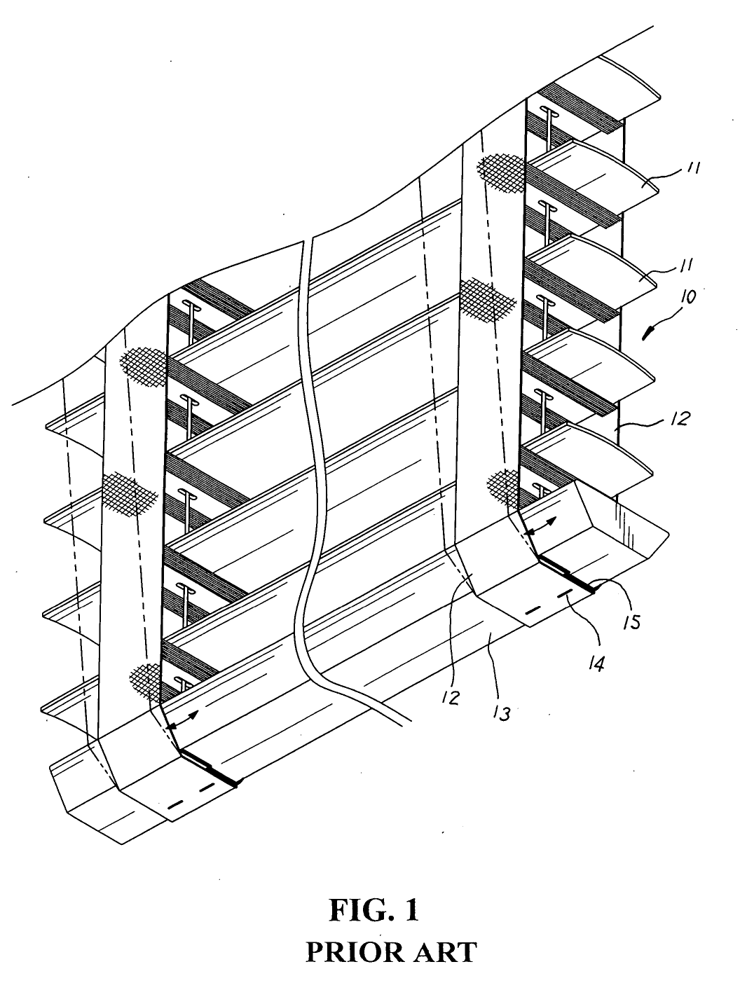

### DETAILED DESCRIPTION OF THE PREFERRED EMBODIMENTS

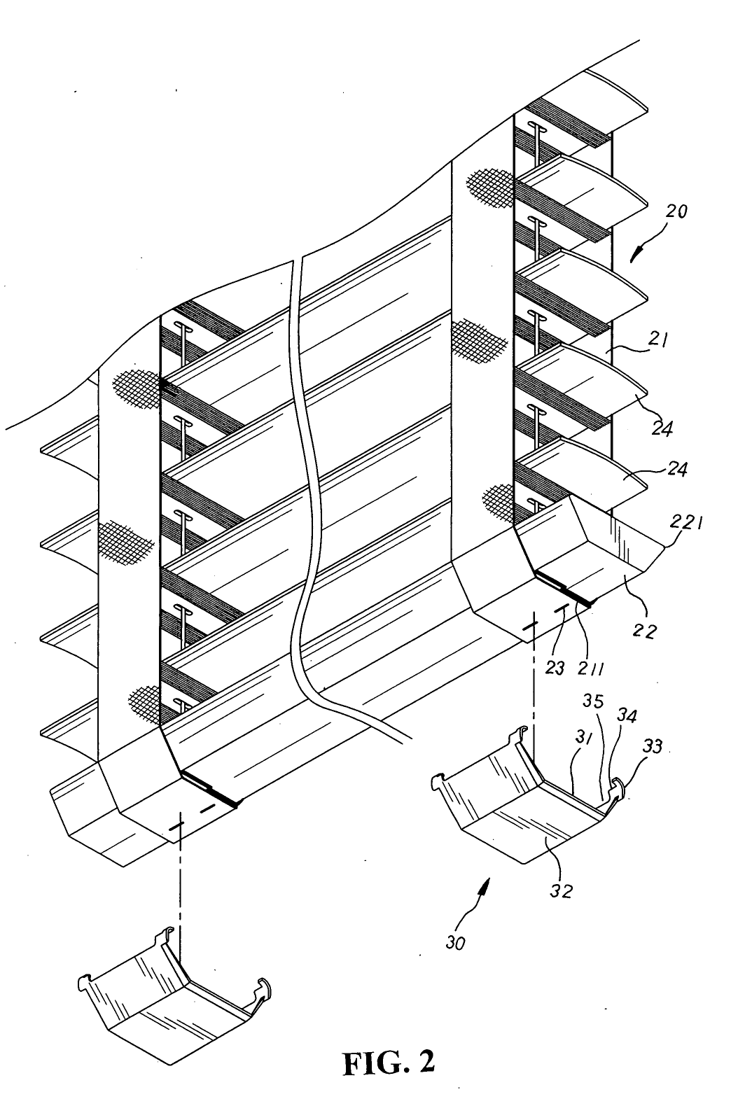

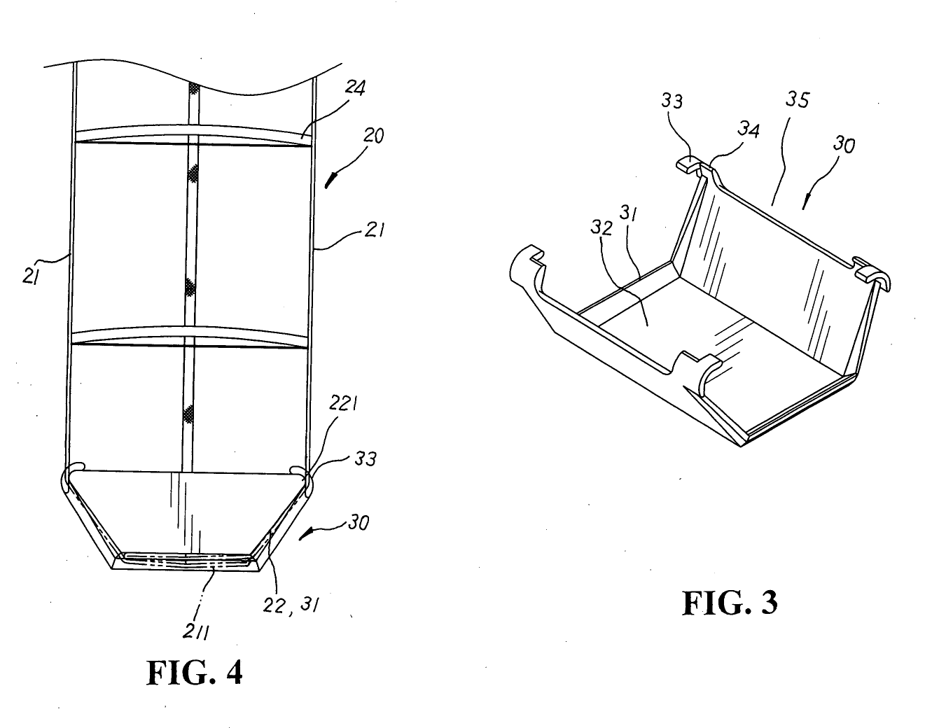

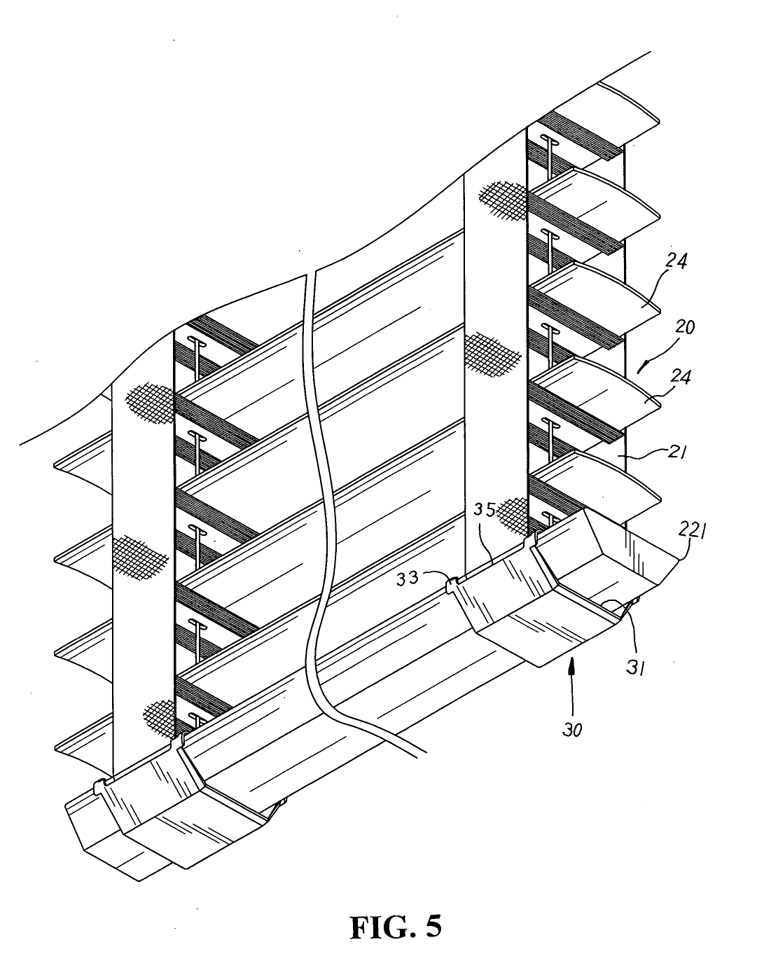

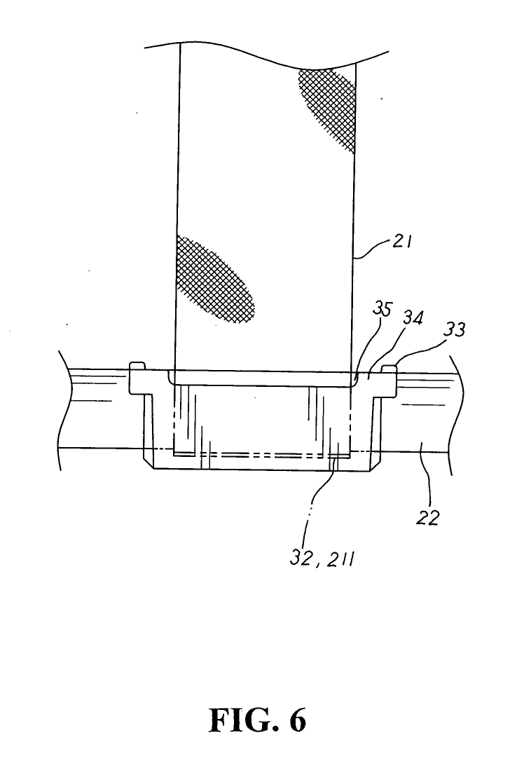

Please refer to FIG. 2 showing an exploded perspective view of the present invention. The present invention is related to a ladder tape and bottom rail positioning structure for Venetian blinds, comprising a Venetian blind 20 made up of head and bottom rails, lift cords, wide-type ladder tapes, pulley seats, and a plurality of slats. The ladder tape 21 has both ends extending to wind around the underside of the bottom rail 22 with an overlapping portion 211 formed thereon. Multiple stapling elements 23 are applied to fix the overlapping portion 211 thereof onto the underside of the bottom rail 22, permitting the ladder tape 21 to suspend downwards in a U shape and secure to the bottom rail 22 for the location of slats 24 arranged in an even spacing thereon. A flexible plastic positioning cover 30 is mounted to the underside of the bottom rail 22 at a location corresponding to the overlapping portion 211 of the ladder tape 21. The positioning cover 30 (referring to FIG. 3), identically formed in the U-shaped configuration of the bottom rail 22, is equipped with a pair of engaging edges 31 symmetrically protruding at both left and right sides of the bottom edges thereon to define there-between a cavity 32 having a width larger than that of the ladder tape 21 thereof, and two sets of symmetrical arcuate insert ends 33 extending at the four corners of the upper edges thereon and identically curved to fit to the shape of longitudinal frame edges 221 of the bottom rail 22 thereby. At the inner side of the symmetrical arcuate insert ends 33 is respectively disposed a lower stop block 34 to define a limiting groove 35 between each pair of the arcuate insert ends 33 thereof. The arcuate insert ends 33 are equipped with a flexibility to slide along the surface of the bottom rail 22 till fittingly hooked to the frame edges 221 thereof as shown in FIG. 4, permitting the engaging edges 31 of the positioning cover 30 to abut precisely against the underside of the bottom rail 22 so as to conceal the overlapping portion 211 of the ladder tape 21 and the stapling elements 23 inside the cavity 32 as shown in FIG. 5, efficiently achieving the decorative purpose thereby and providing a delicate finish to the appearance of the Venetian blind 20 so as to boost its quality as a whole. Moreover, the stop blocks 34 are precisely located adjacent to both lateral edges of the ladder tape 21 and flexibly abutted against the frame edges 221 thereof, permitting stable location of the ladder tape 21 clamped between the positioning cover 30 and the bottom rail 22 and restrained by the stop blocks 34 to accommodate in the limiting groove 35 thereof as shown in FIG. 6. Thus, the ladder tape 21 can be stably held in place and avoid the risk of swinging or sliding left and right over the surface of the bottom rail 22 when the Venetian blind 20 is affected by outer force like the blowing of wind or the operation of the lift cords. In operation, the ladder tape 21 can synchronically move with the bottom rail 22 in a smooth and steady manner to achieve the best state of application thereof.

What is claimed is:

1. A ladder tape and bottom rail positioning structure for Venetian blinds, comprising
a Venetian blind made up of head and bottom rails, lift cords, wide-type ladder tapes, pulley seats, and a plurality of slats wherein the ladder tape has both ends extending to wind around the underside of the bottom rail with an overlapping portion formed thereon and secured thereto via a plurality of stapling elements, permitting the ladder tape to suspend downwards in a U shape for the location of the slats thereon in an even spacing; the present invention being characterized by that;
a positioning cover having insert ends extending thereon is applied to mount to the underside of the bottom rail at a position corresponding to the overlapping portion of the ladder tape, permitting the positioning cover to precisely conceal the overlapping portion of the ladder tape and the stapling elements therein for decorative purpose thereby; moreover, the insert ends of the positioning cover are accurately located adjacent to both lateral sides of the ladder tape to form limiting grooves there-between, permitting stable location of the ladder tape clamped between the positioning cover and the bottom rail and restrained to accommodate in the limiting groove thereof so that the ladder tape can synchronically move with the bottom rail in an even and steady manner, efficiently achieving the best state of application thereof.

2. The ladder tape and bottom rail positioning structure for Venetian blinds as claimed in claim 1 wherein the positioning cover is identically formed in the U-shaped configuration of the bottom rail thereof.

3. The ladder tape and bottom rail positioning structure for Venetian blinds as claimed in claim 1 wherein the positioning cover can be made of flexible plastic material.

4. The ladder tape and bottom rail positioning structure for Venetian blinds as claimed in claim 1 wherein the insert ends of the positioning cover are symmetrically disposed protruding at the four corners of the upper edges thereon.

5. The ladder tape and bottom rail positioning structure for Venetian blinds as claimed in claim 1 wherein the insert ends of the positioning cover are identically shaped to fit to the longitudinal frame edges of the bottom rail.

6. The ladder tape and bottom rail positioning structure for Venetian blinds as claimed in claim 1 wherein insert ends of the positioning cover can be curved and shaped into an arcuate configuration.

7. The ladder tape and bottom rail positioning structure for Venetian blinds as claimed in claim 1 wherein at the inner side of each insert end of the positioning cover is disposed a lower stop block.

8. The ladder tape and bottom rail positioning structure for Venetian blinds as claimed in claim 1 wherein the insert ends of the positioning cover are equipped with a flexibility and are able to be elastically slid along the surface of the bottom rail till fittingly hooked to the frame edges of the bottom rail.

9. The ladder tape and bottom rail positioning structure for Venetian blinds as claimed in claim 1 wherein the positioning cover also includes a pair of engaging edges symmetrically protruding at the left/right sides of the bottom edges thereon to define there-between a cavity having a width larger than that of the ladder tape thereof and corresponding to the overlapping portion of the ladder tape thereof.
